(19) United States
(12) Patent Application Publication
(10) Pub. No.: US 2023/0194046 A1
(43) Pub. Date: Jun. 22, 2023

(54) ARRAY FRAME ADAPTER

(71) Applicant: Joseph G. MCNARY, VERNON, VT (US)

(72) Inventor: Joseph G. MCNARY, VERNON, VT (US)

(21) Appl. No.: 17/555,398

(22) Filed: Dec. 18, 2021

(51) Int. Cl. F16M 13/02; H04R 1/02; F16M 11/20

(52) U.S. Cl. CPC F16M 13/022; H04R 1/026; F16M 11/2021; H04R 2201/025

(57) ABSTRACT

An array frame adapter for positioning flying speaker arrays in sound rigs enables a user to expediently create a desired tilt angle of an entire speaker array by singlehanded action applied to rotate a threaded drive member. The threaded drive member is operationally coupled to a lever arm which is caused to pivot as the threaded drive member is rotated. The lever arm is caused to travel incrementally between a first position and a second position within an arcuate track to produce a maximum tilt angle of the suspended array.

### BACKGROUND OF THE INVENTION

Erecting speaker arrays for large events is a complex undertaking. Large groups of speakers must be oriented to avoid interference between sound waves produced from separate stacks to faithfully represent the intended sound to as many listeners as possible. Larger events spread crowds of listeners over large areas.

As such, speaker arrays are typically suspended from overhead frames and hoisted to desired heights. This allows for more room at ground level to accommodate crowds and presents stacks as point sources for sound production. Because of the number of speakers involved, especially in large events, speakers are individually tilted in each array to produce a desired sound pattern, and individual arrays are also tilted in combination with other arrays within the same system. The undertaking is complex; adjusting tilt angles can be time consuming and challenging often requiring setting a tilt angle and then resetting after other adjustments are made elsewhere in the system.

To assist in this endeavor, various array frame adapters are seen in the art, devised to attach to array frames and enable tiling the array en masse to lessen the time needed to tinker with individual speakers and arrays in perfecting a desired tilt angle in concert with other arrays communicating in the same system. U.S. Pat. No. 5,758,852 to Martin, for example, provides for a plurality of individual frame members that are mounted to each speaker and then connected together by means of a plurality of coupling elements which lock together in a variety of positions by means of adjustment locks. This allows for the speakers comprising an array to be individually oriented with respect to one another and for the arrays themselves to be hoisted and suspended with minimal suspension points. U.S. Pat. No. 5,819,959, also to Martin, relies on myriad truss bars that are joined together in locking slip sleeves. Speakers can be joined into an array and then individually oriented within the array by means of setting individual slpay angles between the truss bars. These are good examples of systems devised to enable grouping of speakers into arrays while providing for adjustable orientation for each speaker comprising the array. In both cases, however, individually setting and resetting orientations can be time consuming, especially when the arrays are already hoisted.

U.S. Pat. No. 7,298,860, to Engebretson et al. is directed to assemblage of an adjustable line array of speakers for rigging. Adjustable hinge bars form and rigidly maintain splay angles between adjacent speakers in the line array. The array is then suspended at an uppermost speaker. U.S. Pat. No. 7,997,552, also to Engebretson et al. is similarly directed to maintaining splay angles through a line array by action of a modular rigging bar that includes a pivotal member to enable orientation of speakers relative to each other when building an array to a frame.

U.S. Pat. No. 8,126,184, to Parker, involves a system and method for securing at least one speaker to an overhead structure. Insofar as Parker discloses means of orienting the at least one speaker, his device could be usable to orient an entire line array were it suspended at the uppermost speaker to Parker's gimbal. However, Parker's system requires supporting the weight of the speakers during disassembly and resetting of a collar member in order to set the desired position. Further, the speakers must be supported when removing and replacing support pins that are devised to prevent pivotal action of various pivots. This may require lifting and lowering arrays in order to render adjustments.

U.S. Pat. No. 9,140,404, to Akrep, provides a rigging system adaptor which enables adjustment of an entire line array, especially when in use with a spine frame. Lateral rods enable slidable engagement of an attachment member along a longitudinal span but require multiple points of contact to make an adjustment. Additional array frame adapters are seen in the art.

What is needed is a rigging system array frame adapter that, like Akrep, allows for a plurality of tilt angles rendered to an array but with minimal points of contact, whereby arrays may be tilted and oriented once suspended by manual adjustment to enable fine tuning of the system across large areas without having to lower each array, support the speakers, or manually interact with multiple points of contact.

### FIELD OF THE INVENTION

The present invention relates to an array frame adapter for orienting tilt angles to speaker arrays, and more particularly, to an array frame adapter that enables a range of tilt angles be adjusted while the array is suspended from a single point of contact.

### SUMMARY OF THE INVENTION

The present array frame adapter allows for a single point of suspension for a line array while presenting a single point of contact to adjust the array tile angle. The present array frame adapter is attachable to an array frame as a hoist point from which to raise and suspend flying arrays. Once lifted, the entire array may be tilted between a range of tilt angles by manual action effectuated to a single point of contact. The present array frame adapter, therefore, is an efficient means to secure flying arrays and orient the said arrays in concert to minimize interference, without a user having to repeatedly raise and lower arrays to render an adjustment or having to move between various points of contact to manually set a desired or test orientation.

The present array frame adapter, therefore, is attachable to an array frame and usable to orient a desired tilt angle. The array frame adapter includes at least one axial support member that defines a base span along a longitudinal extent. The base span includes a first end and a second end at either end of the span and a basal attachment member is disposed at each of the first and second end. The basal attachment members are devised for connection to a frame attached to a speaker or the uppermost speaker of a line array, as will be described subsequently. The at least one axial support member also includes at least one arcuate track disposed therein, said arcuate track disposed arced above the base span.

A lever arm is pivotally connected proximal the base span of the at least one axial support member. The lever arm includes at least one aperture for connection with a hoist or suspension means whereby the array frame adapter is suspensible. The lever arm is situated to be moveable between a first position and a second position, which positions are delimited at opposite extremes of the arcuate track member. The lever arm is thus movable from the first position, in acute angular relationship to the base span; through a mid-position, in right-angular relationship with the base span; to the second position, in an obtuse position relative to the base span and in comparison to the first position (that is, the angle between the lever arm and the base span is acute or obtuse only in relation to a particular side of the lever arm).

In at least one embodiment exemplified herein, the lever arm includes a fastening member disposed in communication with the lever arm and oriented transversely through the arcuate track, whereby the fastener member travels along the arcuate track and is contained within the delimit of the said arcuate track in concert with movement of the lever arm. The fastener member may also stabilize the lever arm in the desired position corresponding to a set tilt angle, as will be described subsequently.

Securable movement of the lever arm between the first position and the second position is effectuated by rotational action of a threaded drive member. The threaded drive member is disposed upon the axial support member in operational communication with the lever arm whereby rotation of the threaded drive member effectuates movement of the lever arm between the first and second positions. In an example embodiment disclosed herein, the threaded drive member is mounted to the axial support by means of a first bracket member and operatively coupled to the lever arm by means of a second bracket member. The first bracket member is disposed upon the at least one axial frame member and engages a head end of the threaded drive member. Rotation of the head end of the threaded drive member is accommodated interior to the first bracket member, whereby 360° rotation of the head end is enabled without engaging threads or causing lateral movement of the threaded drive member relative to said first bracket member.

The second bracket member is disposed upon the lever arm. The threaded drive member is threadably engaged through the second bracket member such that rotation of the threaded drive member in each of a first and a second direction effectively translocates the bracket member along the length of the threaded drive member incrementally, as controlled by action of the thread, whereby the lever arm is caused to move between the first and second positions in response to rotation of the threaded drive member in each of a corresponding first and second direction. This allows for precise and controlled positioning of the lever arm angled relative to the base span, between the first and second positions, to enable a range of tilt angles corresponding to the angular relationship between the lever arm and the base span. For example, when the lever arm s at the mid-position, the angular relationship between the base span and the lever arm is 90° and an array frame secured to the base span (as will be described subsequently) is disposed in parallel with the base span and is therefore positioned with the frame in horizontal orientation. When the threaded drive member is rotated in the first direction, and the lever arm is moved to the second position, one end of the base span is effectively raised while the other end is effectively lowered. Once the lever arm attains the second position, a maximum tile angle is achieved relative to the second end of the base span. The center of gravity of the suspended array is directly aligned with the lever arm. Conversely, rotation of the threaded drive member to position the lever arm in the first position, lowers the second end and raises the first end to a maximum tilt angle relative to the first end. The center of gravity of the array is maintained aligned with the lever arm.

The instant array frame adapter, therefore, enables a single point of suspension and a single point of contact to adjust a tilt angle between maximum tilt angles defined by the arcuate track member. In some embodiments contemplated herein, the headend of the threaded drive member may be engaged by a handheld power tool, such as a handheld drill, whereby rapid and expedient tilting can be effectuated by a user at a single point of contact.

Thus has been broadly outlined the more important features of the present array frame adapter so that the detailed description thereof that follows may be better understood and in order that the present contribution to the art may be better appreciated.

Objects of the present array frame adapter, along with various novel features that characterize the invention are particularly pointed out in the claims forming a part of this disclosure. For better understanding of the array frame adapter, its operating advantages and specific objects attained by its uses, refer to the accompanying drawings and description.

### BRIEF DESCRIPTION OF THE DRAWINGS

### Figures

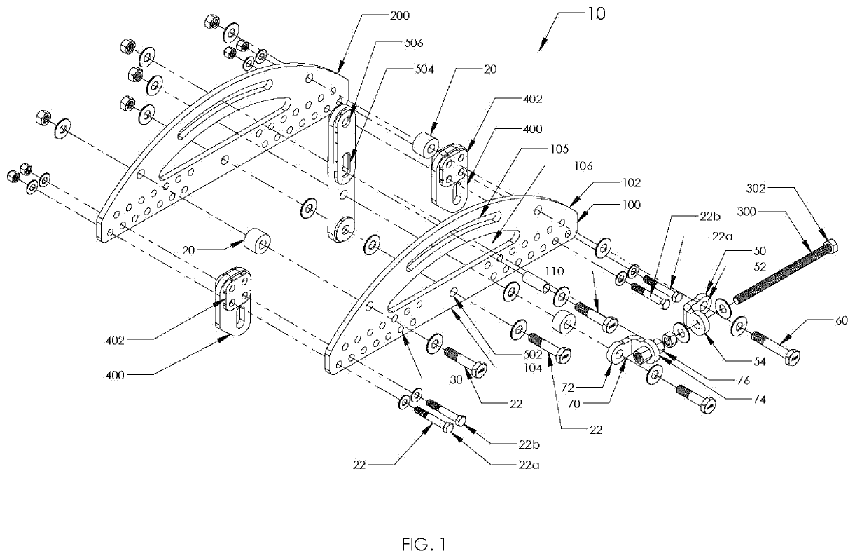

FIG. 1 is an exploded right diagonal elevation view of an example embodiment.

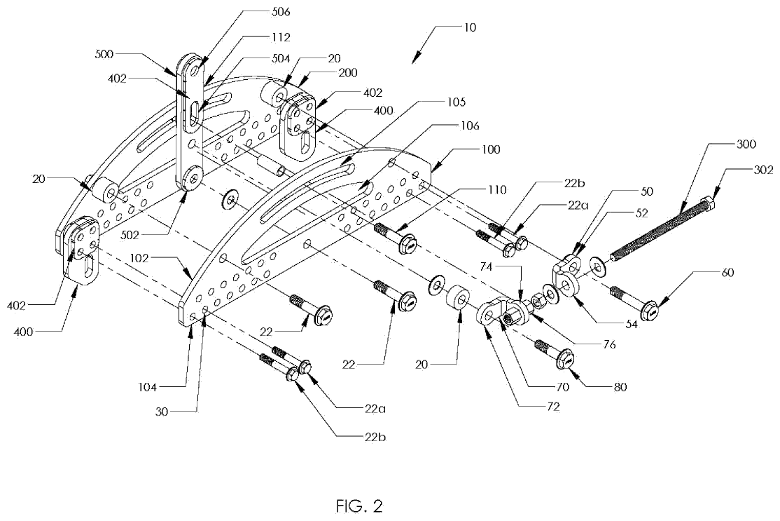

FIG. 2 is a partially exploded right diagonal elevation view of the example embodiment shown in FIG. 1.

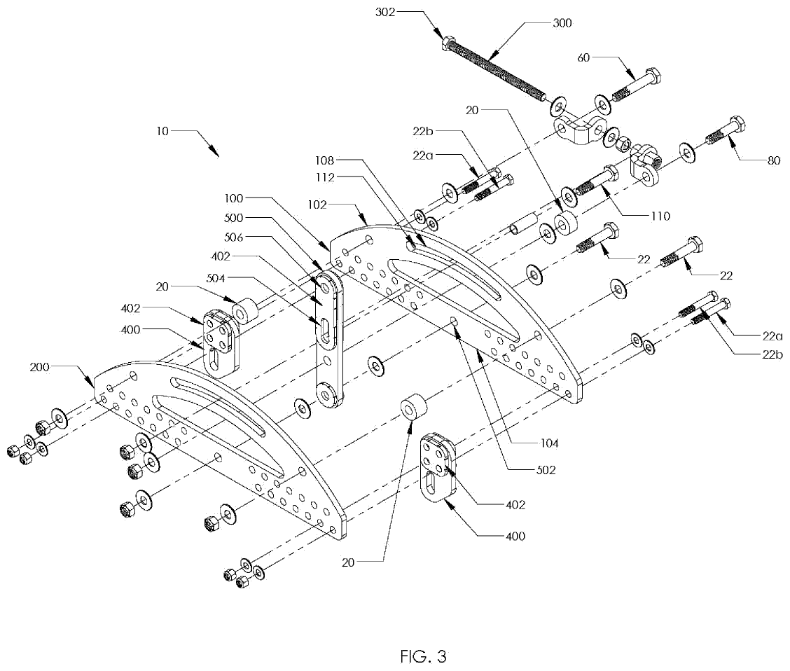

FIG. 3 is an exploded left diagonal elevation view of the example embodiment.

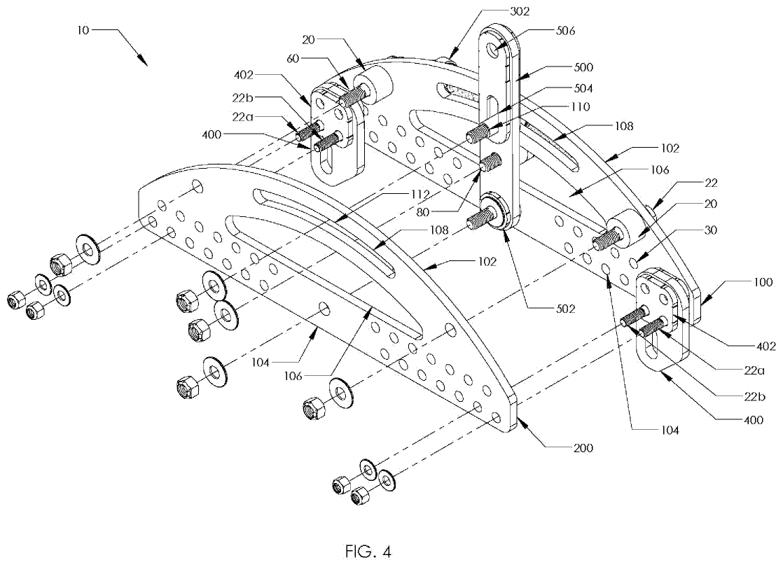

FIG. 4 is a partially exploded left diagonal elevation view of the example embodiment.

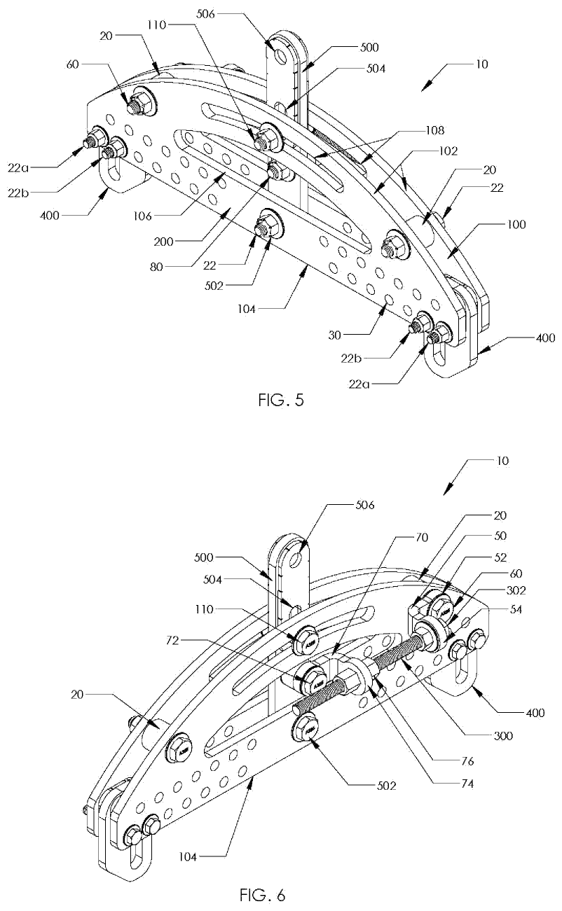

FIG. 5 is a left diagonal elevation view of the example embodiment.

FIG. 6 is a right diagonal elevation view of the example embodiment.

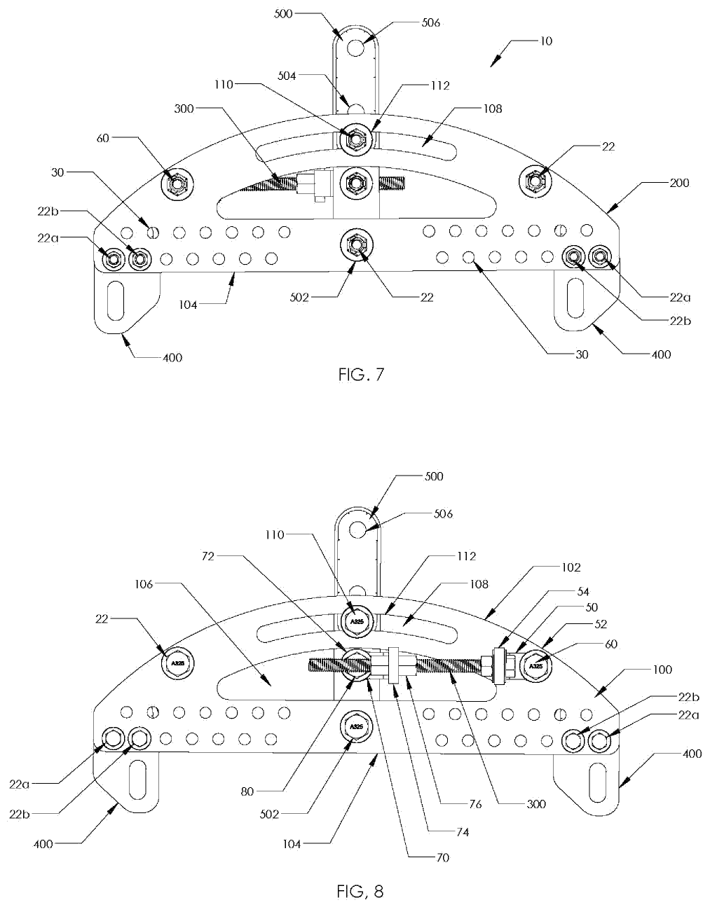

FIG. 7 is a left elevation view of the example embodiment.

FIG. 8 is a right elevation view of the example embodiment.

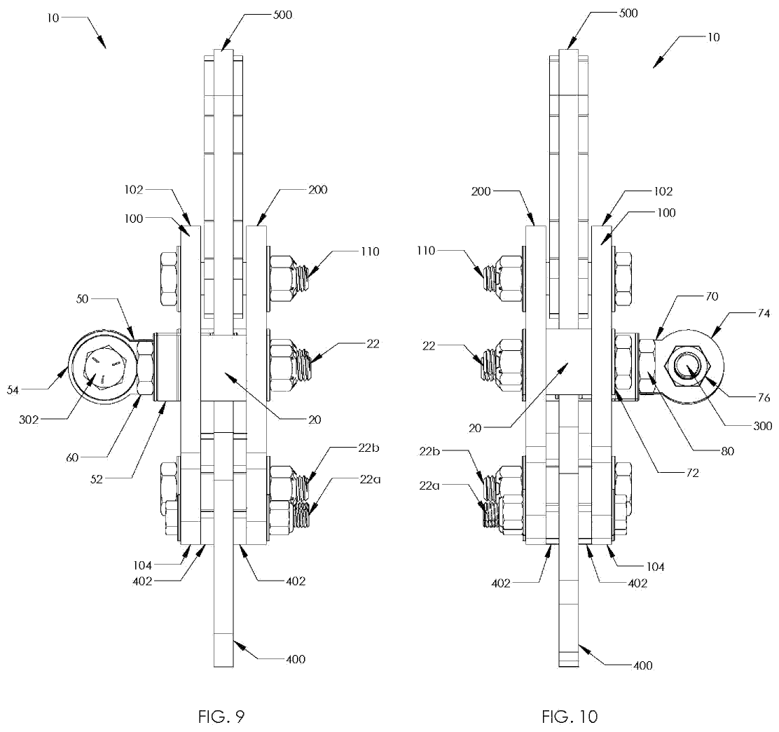

FIG. 9 is a rear elevation view of the example embodiment.

FIG. 10 is a front elevation view of the example embodiment.

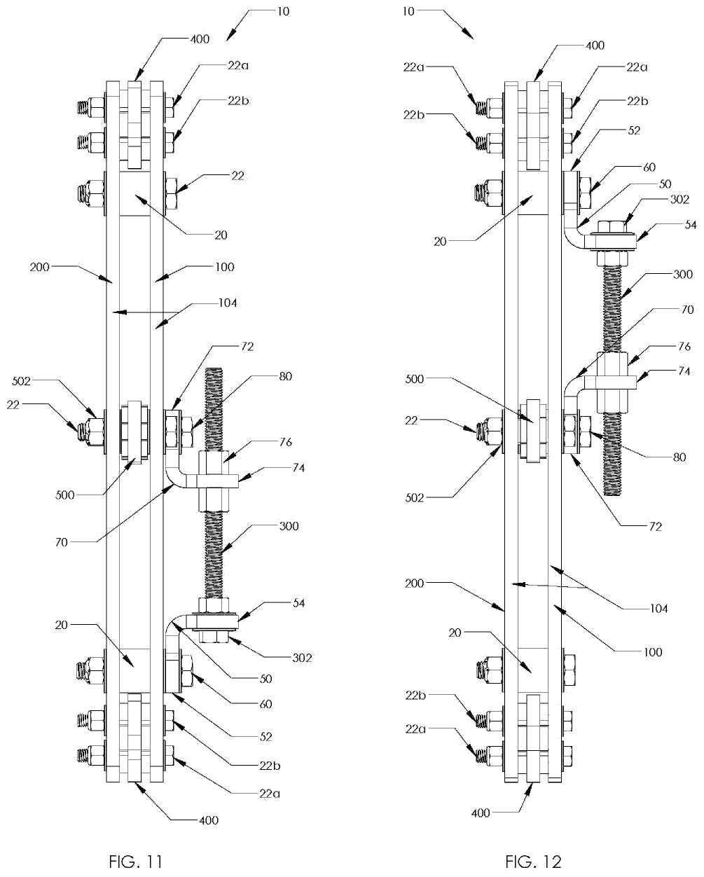

FIG. 11 is a bottom elevation view of an example embodiment.

FIG. 12 is a top elevation view of an example embodiment.

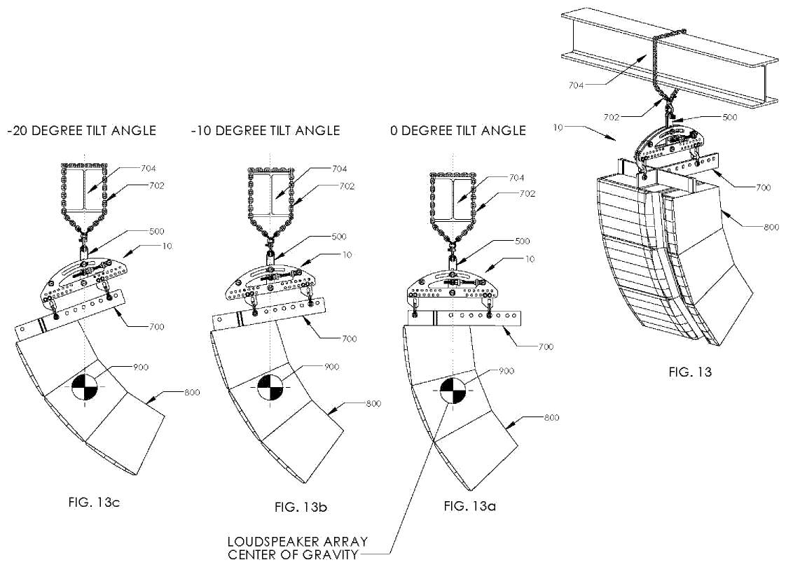

FIG. 13 is an in-use right diagonal elevation view illustrating the invention in-use with an array frame to position a column of speakers at a desired tilt angle, wherein FIGS. 13a, b, and c are right side elevation views showing a change in tilt angle.

### DETAILED DESCRIPTION OF THE DRAWINGS

The following drawings are presented as examples only, illustrating a preferred or exemplary embodiment of the present invention whereby the metes and bounds of the inventive subject material may be better ascertained.

Persons of ordinary skill in the art will appreciate that additional or alternative structures and arrangements of parts may be used and accommodated without deviating from the general scope of the invention as set forth particularly in the accompanying claims. The instant drawings are therefore provided to exemplify certain features of the invention that enable a competent reduction to practice without intending to limit the inventive scope to the embodiment portrayed.

Referring now to FIG. 1, an exploded front elevation view of an example embodiment of the present invention 10 is disclosed. The exploded view is provided to illustrate the various parts and features of an embodiment that meets the limitations set forth in the accompanying claims and which exemplifies merely one manner in reducing the invention to practice. Referring to FIG. 1, then, an exemplary array frame adapter 10 is depicted. Array frame adapter 10 is attachable to an array frame (see FIG. 13) and is usable to orient a desired tilt angle by movement of lever arm 500 relative to a pair of axial support members 100, 200, as will be described subsequently.

The pair of support members 100, 200 includes first axial support member 100 and second axial support member 200. Second axial support member 200 is disposed in parallel with first axial support member 100. Each axial support member 100, 200 includes an arched upper edge 102 disposed spanned over a linear base span 104. The perimeter of each axial support member 100, 200 delineates a section of a circle, wherein the base span 104 represents a diameter or chord of the said circle and the arched upper edge 102 represents the section of the circumference bisected by said diameter or chord. Cutout sections 106 further enable coupling of second bracket member 70 to lever arm 500 and threaded drive member 300. Cutout sections therefore 106 accommodate controllable movement of lever arm 500 by action of threaded drive member 300 operationally communicating with drive collar 76 and lever arm 500, as will be described subsequently.

Arcuate track 108 is disposed in each of the axial support members 100, 200. Arcuate track 108 runs approximately in parallel with upper edge 102 at least partially. Arcuate track 108 delimits a range of travel of lever arm 500 whereby a tilt angle is producible between the position of lever arm 500 along arcuate track 108 relative to the base span 104, a will be described subsequently.

As shown in FIGS. 1, 2, 3 and 4, the pair of axial support members 100, 200 is secured together and spaced apart by means of a plurality of spacer elements 20. Fastener members 22 are provided to secure the axial support members 100, 200 together, engaged on either side of associated spacer elements 20. Lever arm 200 and two attachment members 400 are disposed secured in between the axial support members 100, 200. Attachment members 400 are disposed projected downwards to protrude beneath the base span 104 of each of the axial support members 100, 200 and are provided for attachment to an associated array frame 900 to which the instant adapter is connected (see, e.g., FIG. 13). Attachment members 400 may include reinforcing spacers 402 on either side of an upper portion thereof.

Lever arm 500 is rotationally secured at midpoint 502, secured in between axial support members 100, 200 proximal each base span 104. Lever arm 500 includes elongate aperture 504 disposed to position superimposed along arcuate track 108 and apical aperture 506 for interconnection with rigging (see, e.g., FIG. 13). Fastening member 110 is disposed through arcuate track 108 and elongate aperture 504 to enable securable travel of lever arm 500 held along arcuate track 108. Fastening member 110 serves to render taut engagement of lever arm 500 and stabilizes the array frame adapter 10 in use. Fastening member 110 is rotationally adjustable to loosen or tighten engagement of lever arm 500 securably within arcuate track 108.

Threaded drive member 300 is disposed upon first axial support member 100 in parallel with base span 104. Threaded drive member 300 is secured proximal to one end of axial support member 100 by means of first bracket member 50. First bracket member 50 includes a first end 52 rotatably secured to axial support member 100 by means of fastener member 60. Such engagement allows for some rotational play by the first bracket member 50 around a range of rotation in relation to the axial support member 100; although it is intended that fastener member 60 be tautly engaged therethrough. First bracket member 50 further includes second end 54 disposed right-angularly relative to first end 52. Second end 54 is positioned for engagement with headend 302 of threaded drive member 300, when threaded drive member 300 is inserted therethrough. First bracket 50 second end 54 is not threaded: headend 302 of threaded drive member 300 is therefore rotational therein without effectuating travel of threaded drive member 300 relative to first bracket member 50.

Second bracket member 70 is disposed rotationally secured to lever arm 500 by fastener member 80. Second bracket 70 member likewise includes a first end 72 through which fastener member 80 serves to secure second bracket member 70 to lever arm 500. Second bracket member 70 likewise includes a second end 74, right-angularly disposed relative to first end 72. Second end 74 is interiorly threaded and includes drive collar 76. Thus, when threaded drive member 300 is caused to rotate in a first direction, drive collar 76 is translocated in a corresponding first direction along the length of threaded drive member 300. As such, lever arm 500 is likewise moved along arcuate track 108 in said first direction. When threaded drive member 300 is caused to rotate in a second direction, drive collar 76 is therefore caused to translocate in a corresponding second direction and lever arm 500 is thereby caused to move along arcuate track 108 in said second direction.

Second bracket 70 first end 72 accommodates some rotational play or give to enable taut engagement of lever arm 500 as lever arm 500 is positioned along arcuate track 500 when threaded drive member 300 is rotated.

Lever arm 500 is thus controllable between a first position and a second position delimited by extremities of arcuate track 108. A tilt angle is therefore producible, corresponding to each of the first and second positions. A 0° tilt angle is effectuated when lever arm is perpendicularly disposed relative the base span 104. A maximum tilt angle is achieved at either of the first or second positions, angularly situating lever arm 500 acutely relative to base span in each of a first and second direction. The maximum tilt angle is delimited by the length and curvature of arcuate track 108.

FIGS. 5 and 6 illustrate the array frame adapter 10 in assembled form. FIG. 5, showing a left side of the array frame adapter 10 in prominence, illustrates fastener members' 22 engagement of axial support members 100, 200. Lever arm 500 is disposed at a right angled position at acme 112 of arcuate track 108. FIG. 6, showing a right side of the array frame adapter 10 in prominence, illustrates threaded drive member 300 disposed secured to axial support member 100 by means of first bracket member 50. Second bracket member 70 is secured to lever arm 500 beneath elongate aperture 504 and is operationally coupled to threaded drive member 300 at second end 74 wherein drive collar 76 is enabled travel along threaded drive member 300 when threaded drive member 300 is rotated in each of a first and second direction. Correspondingly, lever arm 500 is therefore moveable incrementally and with precision between each of a first and second position delimited by arcuate track 108.

FIGS. 7 and 8 are side elevation views. FIG. 7 illustrates a left side elevation view. Extent of attachment members 400 protrusion beneath base span 104 is visible. Fastener members 22a and 22b may be used to securely relocate attachment members 400 into any of the corresponding holes 30 disposed in each of the axial support members 100, 200 base span 104. FIG. 8 illustrates a right side elevation view. Lever arm 500 is depicted perpendicularly disposed relative to base span 104 and drive collar 76. When threaded drive member 300 is rotated to effectuate travel of lever arm delimited by arcuate track 108, movement of second bracket member 70 accommodates angular relation between lever arm and threaded drive member 300. First bracket 50 does likewise. Further, elongate aperture 504 enables play of fastener member 110 along the length of lever arm 500. Such play or give enables operation of the apparatus in taut configuration. It should be noted that all fastener members 22, 60, 80, 110 are independently operable to maintain taut engagement of all associated parts.

FIG. 9 illustrates a rear elevation view, depicting the array frame adapter 10 end on. Threaded drive member 300 is shown protruding trough the drive collar 76 and the second end 74 of second bracket member 70. Spacer element 20 is visible. Lever arm 500 and fastener member 110 are depicted. Attachment member 400 is also depicted secured between axial support members 100, 200, between reinforcing spacers 402.

FIG. 10 illustrates a front elevation view, depicting the array frame adapter 10 from the end opposite to that illustrated in FIG. 9. Headend 302 of threaded drive member 300 is visible in first bracket 50 second end 54. Headend 302 presents a hexagonal profile for torqued engagement by a hand tool (such as a power tool) to effectuate incremental, precise, and taut travel of lever arm 500 along arcuate track 108 (not visible).

FIG. 11 illustrates a bottom elevation view. Spacer elements 20 are visible as are reinforcing spacers 402. First ends 52, 72 and second ends 54, 74 of first and second brackets 50, 70 are clearly shown. FIG. 12 illustrates a top elevation view, highlighting features in similar capacity as FIG. 11.

FIG. 13 illustrates the array frame adapter 10 in use. Attachment members 400 are attached to an array frame 700 supporting a suspended speaker array 800. Lever arm 500 is attached to rigging 702 connected to scaffold portion 704. FIG. 13a is a right side elevation view of the array frame adapter 10 in use supporting a suspended speaker array at a 0° tilt angle. Center of gravity 900 is marked for purposes of illustration. FIG. 13b is a right side elevation view of the array frame adapter 10 in use supporting the suspended speaker array 800 at a −10° tilt angle. Center of gravity 900 is aligned with lever arm 500. FIG. 13c is a right side elevation view of the array frame adapter 10 in use supporting the suspended speaker array 800 at a −20° tilt angle. Center of gravity 900 is aligned with lever arm 500. Maximum tilt angle in this example embodiment is −30°.

In an example embodiment contemplated as part of this disclosure, the axial support members 100, 200, lever arm 500, attachment members 400, and first and second bracket members 50, 70 are comprised of ASTM A36 steel. Other appropriate materials may be employed that are appropriate to bear the loads required.

What is claimed is:

1. An array frame adapter attachable to an array frame and usable to orient a desired tilt angle, said array frame adapter comprising:
at least one axial support member comprising:
an arcuate track;
a base span;
a lever arm pivotally connected proximal the base span of the at least one axial support member, said lever arm moveable between a first position and a second position delimited by the arcuate track;
a threaded drive member disposed upon the axial support member, said threaded drive member disposed in operational communication with the lever arm; and
at least one basal attachment member disposed upon the base span for interconnection with an existing array frame;
wherein rotation of the threaded drive member effectuates movement of the lever arm along an arc delimited by the arcuate track whereby the base span is oriented through a range of angular positions relative to the lever arm.

2. The array frame adapter of claim 1 further comprising:
a first bracket member disposed upon the at least one axial support member;
a headend of the threaded drive member secured to the at least one axial support member by engagement within the first bracket;
wherein rotation of the headend of the threaded drive member is accommodated interior to the first bracket member.

3. The array frame adapter of claim 2 further comprising:
a second bracket member disposed upon the lever arm;
wherein the threaded drive member is threadably engaged through the second bracket member whereby rotation of the threaded drive member in each of a first and a second direction translocates the bracket member along the length of the threaded drive member whereby the lever arm is caused to move between the first and second positions.

4. The array frame adapter of claim 3 wherein the threaded drive member is oriented in parallel with the base span.

5. The array frame adapter of claim 4 wherein first bracket members comprises:
a first end rotationally secured to the axial support member, said first end rotational at least between a first position and a second position that correspond to the respective first and second positions of the lever arm;
a second end, disposed right-angularly relative to the first end, said second end engaging the threaded drive member;
and
the second bracket member comprises:
a first end rotationally secured to the lever arm, said first end rotational at least between a first position and a second position that correspond to the respective first and second positions of the lever arm; and
a second end, disposed right-angularly relative to the first end, said second end engaging the threaded drive member;
wherein travel of the second bracket member along the length of the threaded drive member is accommodated by an amount of corresponding rotation of each first end.

6. The array frame adapter of claim 5 further comprising a fastening member disposed in the arcuate tack to stabilize the lever arm in a desired position.

7. The array frame adapter of claim 6 wherein the at least one basal attachment member includes a pair of basal attachment members, each of said pair of attachment members disposed upon the base span proximal either end of said base span.

8. The array frame adapter of claim 7 wherein the at least one axial support member includes a pair of axial support members, said pair of axial support members secured together and spaced apart by means of at least one spacer element wherein the lever arm is pivotally secured between the pair of axial support members at a position proximal the base span.

9. The array frame adapter of clam 8 wherein each of the pair of basal attachment members is securable between a range of positions in between the pair of axial support members.

10. An array frame adapter attachable to an array frame and usable to orient a desired tilt angle, said array frame adapter comprising:
a pair of axial support members secured together and spaced apart by means of at least one spacer element, said pair of axial support members comprising:
a first axial support member;
a second axial support member;
an one arcuate track disposed in at least one of the axial support members;
a base span disposed upon each of the first and second axial support members;
a lever arm pivotally secured in between each of the pair of axial support members, said lever arm pivotally connected proximal the base span of each of the pair of axial support members and moveable between a first position and a second position delimited by the at least one arcuate track member;
a threaded drive member disposed upon the first axial support member, said threaded drive member disposed in operational communication with the lever arm; and
a pair of attachment members secured in between the pair of axial support members at either end of the base span;
wherein rotational action of the threaded drive member effectuates movement of the lever arm along an arc delimited by the arcuate track whereby the base span is oriented through a range of angular positions relative to the lever arm.

11. The array frame adapter of claim 10 further comprising:
a first bracket member disposed upon the first axial support member;
a headend of the threaded drive member secured within the first bracket;
wherein rotation of the headend of the threaded drive member is accommodated interior to the first bracket member.

12. The array frame adapter of claim 11 further comprising:
a second bracket member disposed upon the lever arm;
a drive collar disposed upon the second bracket;
wherein the threaded drive member is threadably engaged through the drive collar whereby rotation of the threaded drive member in each of a first and a second direction translocates the bracket member along the length of the threaded drive member whereby the lever arm is caused to move between the first and second positions.

13. The array frame adapter of claim 12 wherein the threaded drive member is oriented in parallel with the base span.

14. The array frame adapter of claim 13 wherein first bracket members comprises:
a first end rotationally secured to the axial support member, said first end rotational at least between a first position and a second position that correspond to the respective first and second positions of the lever arm;
a second end, disposed right-angularly relative to the first end, said second end engaging the threaded drive member;
and
the second bracket member comprises:
a first end rotationally secured to the lever arm, said first end rotational at least between a first position and a second position that correspond to the respective first and second positions of the lever arm; and
a second end, disposed right-angularly relative to the first end, said second end engaging the threaded drive member;
wherein travel of the second bracket member along the length of the threaded drive member is accommodated by an amount of corresponding rotation of each first end.

15. The array frame adapter of claim 14 further comprising a fastening member disposed in the arcuate tack to stabilize the lever arm in a desired position.

16. The array frame adapter of clam 15 wherein each of the pair of basal attachment members is securable between a range of positions in between the pair of axial support members.
